(19) United States
(12) Patent Application Publication
(10) Pub. No.: US 2026/0064953 A1
(43) Pub. Date: Mar. 5, 2026

(54) HANDLING COMPLEX STRUCTURES FOR SENTENCE PARAPHRASING UTILIZING A LANGUAGE MODEL

(71) Applicant: Adobe Inc., San Jose, CA (US)

(72) Inventor: Wei Zhang, Great Falls, VA (US)

(21) Appl. No.: 18/819,054

(22) Filed: Aug. 29, 2024

(51) Int. Cl. G06F 40/186; G06F 40/295

(52) U.S. Cl. CPC G06F 40/186; G06F 40/295

(57) ABSTRACT

The present disclosure relates to systems, methods, and non-transitory computer readable media for generating augmented insights which paraphrase complicated captions for data charts or data graphs in natural language utilizing a natural language model. In some embodiments, the insight augmentation system generates a modified caption by replacing an entity name within the template-based caption with a placeholder name utilizing a renaming map. Based on the modified caption and utilizing a large language model, in some cases, the insight augmentation system generates a placeholder insight describing the data chart in natural language using the placeholder name. Furthermore, in some embodiments, the insight augmentation system generates an augmented insight describing the data chart in natural language by replacing the placeholder name in the placeholder insight with the entity name.

### BACKGROUND

In the field of data captioning, natural language models increasingly demonstrate their effectiveness in various applications, such as generating captions to explain or summarize data represented in charts and graphs. These models have transformed data captioning, enabling the generation of data captions that paraphrase or summarize large datasets in word form. Additionally, these models have significantly enhanced the ability to rephrase and improve the naturalness of textual captions generated from templates. Despite the advances of existing data captioning systems, however, these prior systems continue to suffer from a number of disadvantages, such as maintaining accuracy and improving computational efficiency when generating naturally phrased data captions for sophisticated or complex sentence structures.

### SUMMARY

This disclosure describes one or more embodiments of systems, methods, and non-transitory computer readable media that solve one or more of the foregoing or other problems in the art by generating naturally phrased insights from template-based captions using insight models. In some embodiments, the disclosed systems train and utilize an insight model with modified captions that are augmented with placeholder names to improve the accuracy and robustness of model predictions for complicated sentence structures. For example, the disclosed systems replace instances of entity names with placeholder names within the template-based captions to generate modified captions and train and/or utilize the insight model. In some cases, the disclosed systems distill parameters learned in a natural language model for generating naturally phrased insights into a distilled insight model that uses far fewer computational resources than large natural language models. Utilizing the modified captions, in some cases, the disclosed systems generate augmented insights describing a data chart or data graph using natural language from template-based captions.

### BRIEF DESCRIPTION OF THE DRAWINGS

This disclosure describes one or more embodiments of the invention with additional specificity and detail by referencing the accompanying figures. The following paragraphs briefly describe those figures, in which:

FIG. 1 illustrates an example system environment in which an insight augmentation system operates in accordance with one or more embodiments;

FIG. 2 illustrates an overview of utilizing a distilled insight model to provide an augmented insight from a template-based caption in accordance with one or more embodiments;

FIG. 3 illustrates an example diagram for generating a modified caption from a template-based caption in accordance with one or more embodiments;

FIG. 4 illustrates an example diagram for generating an augmented insight from a modified caption in accordance with one or more embodiments;

FIG. 5 illustrates an example diagram for generating a placeholder insight from modified captions in accordance with one or more embodiments;

FIG. 6 illustrates an example diagram for distilling a natural language model into a distilled insight model in accordance with one or more embodiments;

FIG. 7 illustrates an example insight interface for generating and presenting an augmented insight in accordance with one or more embodiments;

FIG. 8 illustrates an example schematic diagram of an insight augmentation system in accordance with one or more embodiments;

FIG. 9 illustrates an example flowchart of a series of acts for generating and providing an augmented insight from a caption utilizing a large language model in accordance with one or more embodiments;

FIG. 10 illustrates an example flowchart of a series of acts for prompting and utilizing a natural language model to distill a distilled insight model for generating distilled placeholder insights in accordance with one or more embodiments; and

FIG. 11 illustrates a block diagram of an example computing device in accordance with one or more embodiments.

### DETAILED DESCRIPTION

This disclosure describes one or more embodiments of an insight augmentation system that generates augmented insights which paraphrase complicated captions for data charts or data graphs in natural language by training and implementing large language models. Oftentimes, data captioning models struggle to accurately paraphrase data in graphs or charts when data (and/or its descriptions) includes long, multi-word entity names. To overcome these issues, in some embodiments, the insight augmentation system uses an insight augmentation algorithm to generate modified captions by replacing complex entity names within template-based captions with placeholder names utilizing a renaming map. Based on the modified captions, in some cases, the insight augmentation system generates placeholder insights utilizing a large language model. In some cases, the insight augmentation system generates distilled placeholder insights utilizing a distilled insight model distilled from a natural language model. Furthermore, in some embodiments, the insight augmentation system generates the augmented insights describing the data charts in natural language by replacing the placeholder names in the placeholder insights, or distilled placeholder insights, with the initial/original entity names.

As mentioned above, the insight augmentation system extracts from and replaces entity names within a template-based caption. In some cases, the insight augmentation system generates an entity list and populates the entity list with entity names extracted from the template-based caption. Furthermore, the insight augmentation system sorts the entity list according to entity name lengths (e.g., placing the longer entity names first in the list). Based on the sorted entity list, the insight augmentation system replaces the extracted entity names within the template-based caption with simplified names (e.g., placeholder names).

To replace the extracted entity names with simplified names, the insight augmentation system generates a renaming map that maps each entity name to a placeholder name. For example, the insight augmentation system generates simplified names as placeholder names by combining an entity name designator (e.g., “m”), the longest word of the entity name, and an entity name count (e.g., “1”). In some cases, the insight augmentation system generates placeholder pairs by associating the entity names with placeholder names. In some embodiments, the insight augmentation system populates the renaming map by adding the placeholder pairs to the renaming map in the order of the entity list (according to entity name lengths). In turn, utilizing the placeholder pairs, the insight augmentation system replaces the extracted names of the template-based caption with the simplified names (e.g., placeholder names). In some cases, the insight augmentation system replaces the extracted names in the order of the entity list, replacing longer names first and shorter names last.

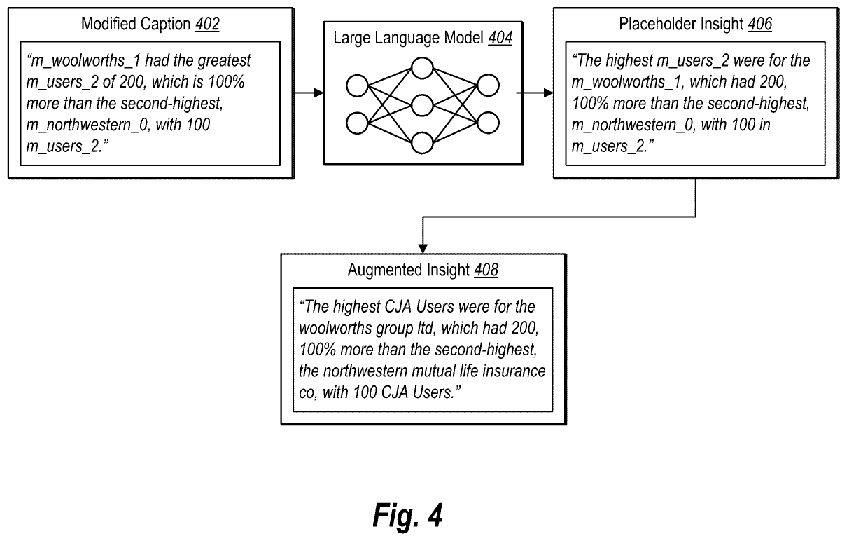

In some embodiments, the insight augmentation system utilizes a large language model to paraphrase the template-based caption in natural language. For example, the insight augmentation system utilizes the large language model to generate natural language phrases for rewording the template-based caption into a more comprehensible structure. In some embodiments, the insight augmentation system uses a large language model to process a modified caption (e.g., the template-based caption incorporating the placeholder names) to convert the modified caption into a placeholder insight. As noted above, the insight augmentation system uses a renaming map to generate a modified caption that includes placeholder names in locations where original entity names were originally placed. In addition, the insight augmentation system inputs such a modified caption into a large language model, whereupon the large language model generates a placeholder insight according to its learned parameters. To elaborate, the insight augmentation system uses a large language model trained on natural language phrases to reword or paraphrase a modified caption into natural phrases while still using the placeholder names in lieu of original entity names. Additional detail regarding using a large language model to generate a placeholder insight from a modified caption is provided below with reference to FIG. 4.

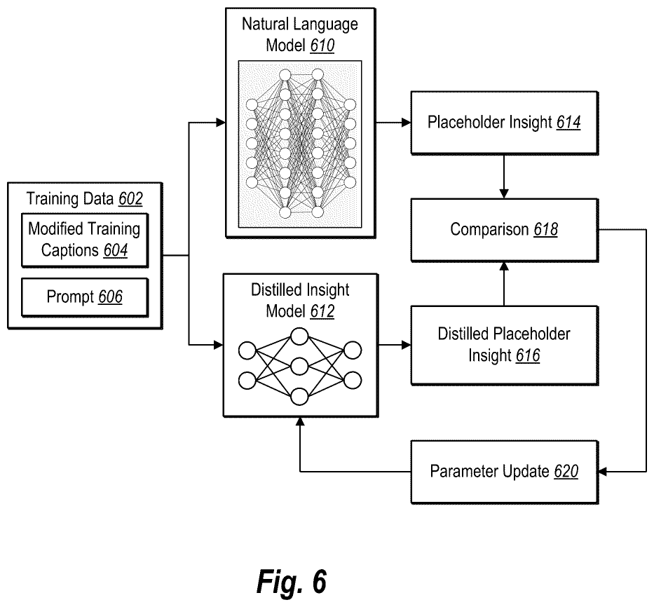

Along similar lines, in some cases, the insight augmentation system utilizes a distilled insight model to process the modified caption and generate a distilled placeholder insight. For example, the insight augmentation system distills parameters of a large language model (or some other natural language model) into a lighter, distilled insight model with far fewer parameters. Indeed, the insight augmentation system uses a larger natural language model with many (e.g., hundreds of millions of) parameters to generate naturally phrased insights and trains a distilled insight model from the parameters of the natural language model. Additional detail regarding the distillation of the distilled insight model is provided below with reference to FIG. 6. Once trained, the insight augmentation system further uses the distilled insight model (trained on the capabilities of the larger natural language model) to generate a placeholder insight. Indeed, the insight augmentation system applies the distilled insight model to generate a placeholder insight from a modified caption, where the placeholder insight describes a data chart in natural language while also incorporating placeholder names (e.g., from the modified caption generated via a renaming map).

Moreover, in some embodiments, the insight augmentation system generates an augmented insight from a placeholder insight. For instance, the insight augmentation system generates an augmented insight by further augmenting or modifying a placeholder insight generated by a large language model and/or a distilled insight model. The insight augmentation system generates an augmented insight to describe a data chart in natural language while reintroducing entity names from an original caption describing the data chart. For example, to generate the augmented insight, the insight augmentation system 106 replaces the placeholder names in the placeholder insight (which is a naturally phrased description of the data chart but with placeholders for entity names) with entity names. Additional detail regarding generating an augmented insight from a placeholder insight is provided below in relation to FIG. 4.

As mentioned above, in some cases, the insight augmentation system distills a natural language model into the distilled insight model. For example, the insight augmentation system distills or transfers parameters of a larger natural language model into a smaller distilled insight model for generating naturally phrased augmented insights. As part of this process, the insight augmentation system prompts a pretrained natural language model to generate or predict placeholder insights from modified captions. In this way, the insight augmentation system utilizes the natural language model to generate placeholder insights from template-based captions modified to incorporate placeholder names (e.g., by replacing multi-word entity names). Continuing the distillation process, the insight augmentation system generates, via the natural language model from the modified training captions, placeholder insights describing data charts in natural language phrases that incorporate placeholder names in place of entity names. The insight augmentation system further distills, in some cases, the natural language model into a distilled insight model by tuning parameters of the distilled insight model such that the distilled insight model generates distilled placeholder insights from the modified captions when tuned. In particular, the insight augmentation system trains the distilled insight model to generate distilled placeholder insights that are similar to the placeholder insights generated by the much larger natural language model.

As suggested above, some prior data captioning systems exhibit a variety of disadvantages or deficiencies, particularly with respect to accuracy and computational efficiency. For instance, some prior systems inaccurately paraphrase complicated data captions, leading to incorrect representations of the data in charts or graphs. For example, due to the complex structure of some captions and the use of multi-word entity names, prior systems often misinterpret the structure of the captions. Indeed, because prior systems retain the complex wording of entity names when paraphrasing the captions, prior systems often misinterpret the caption content. As a result of this misinterpretation, prior systems often focus on extraneous details within the captions, resulting in inaccurately paraphrased captions.

Additionally, prior systems often generate inaccuracies caused by overfitting during training. For example, prior systems retain multi-word entity names which include unique or rare terms, leading to overfitting and reducing prior systems ability to generalize across different contexts. In some cases, prior systems utilize large language models with excess parameters in an attempt to account for complex captions, which also results in overfitting. As a result of overfitting, prior systems often generate data captions or insights that are unnaturally and/or incorrectly phrased. For example, overfitting of prior systems leads to outputs that are mechanical in nature and/or difficult or impossible to interpret.

In addition to being inaccurate, some prior systems are computationally inefficient. Notably, although some prior systems have attempted to utilize reduced size models to paraphrase data captions or insights; unfortunately, these systems are unable to accurately analyze complicated entity names, resulting in hallucinations. As a result, prior systems rely almost exclusively on large language models to paraphrase complicated data captions or insights. However, the operation of large language models requires a substantial amount of computing resources, such as processing power and memory, especially considering the extremely large numbers of parameters within some of these models (e.g., 100+ billion parameters). Not only are these models expensive to train, but they are also expensive to implement at runtime. Thus, for each request or query to generate a data caption in a prior system that uses a large language model, the system expends excessive computational resources that could otherwise be preserved with a more efficient model. Such computational expenses become especially pronounced across systems that process large numbers of requests and generate large numbers of data captions.

As just suggested, embodiments of the insight augmentation system provide a variety of improvements or advantages over conventional data captioning systems. For example, embodiments of the insight augmentation system improve accuracy over prior data captioning systems. Indeed, while some prior systems generate erroneous or incorrect data captions due to retaining complex entity names, the insight augmentation system utilizes placeholder names which enable the distilled insight model to recognize and apply syntactic and semantic patterns more accurately, leading to naturally phrased and contextually appropriate paraphrases. Additionally, by utilizing the placeholder names, the insight augmentation system utilizes a more generalized training dataset resulting for training a distilled insight model which mitigates the risk of overfitting. Furthermore, in some embodiments, the insight augmentation system distills a natural language model into a distilled insight model with far fewer parameters, which prevents overfitting issues exhibited in larger models. As a result, the insight augmentation system generates insights that are not only more accurate than those of prior systems but also more naturally phrased (and therefore more interpretable).

To elaborate, the insight augmentation system achieves a superior (e.g., smaller) hallucination rate in comparison to prior systems. In particular, experimenters have demonstrated that embodiments of the insight augmentation system 106 achieve a hallucination rate between 1-6% when paraphrasing complicated captions utilizing the Flan-T5 Small. Furthermore, by training the insight model using placeholder names, experimenters have also demonstrated that some embodiments of the insight augmentation system achieve a reduction of 50% in the hallucination rate. In contrast, current reduced size models (Flan-T5 Small) have been shown to generate a rate of 95% hallucinations when paraphrasing complicated captions. Furthermore, the larger size models of current systems also exhibit a significant hallucination rate when paraphrasing complex captions. For example, a larger sized model with 11 billion parameters (Flan-T5 XXL) exhibits a nearly 20% hallucination rate, and a larger sized model with 540 billion parameters (Google's Pathways Language Model) exhibits a 27% hallucination rate. Notably, even the very large models of current systems with 175 billion parameters (GPT 3.5) hallucinate significantly at an almost 4% hallucination rate.

In addition to improved accuracy, embodiments of the insight augmentation system are more computationally efficient than prior systems. As mentioned, as a result of an unacceptable level of hallucinations generated by reduced sized models, prior systems rely on computationally expensive large language models to generate data captions for complicated captions. In contrast, some embodiments of the insight augmentation system utilize a distilled insight model (that includes fewer than 500 million parameters or fewer than 100 million parameters) to generate distilled placeholder insights. Thus, the insight augmentation system preserves significant computer resources compared to prior systems at runtime, without sacrificing the accuracy of large language models. In some cases, the computational savings are substantial, where a natural language model of 11 billion parameters (45 GB in size) is distilled into a distilled insight model of 80 million parameters (310 MB in size).

As illustrated by the foregoing discussion, the present disclosure utilizes a variety of terms to describe features and benefits of the environment management system. Additional detail is now provided regarding the meaning of these terms.

As used herein, the term “entity name” includes or refers to words used to represent named entities. For example, an entity name includes specific terms or phrases that represent named entities within a structured sentence. In some embodiments, an entity name includes or refers to one or more words indicating proper or improper nouns such as names of people, organizations, locations, dates, and other specific terms. In some cases, an entity name incorporates multiple consecutive words to indicate the entity name. In some cases, the insight augmentation system utilizes pre-defined or designated entity names.

Similarly, as used herein, the term a “entity name length” includes or refers a length of an entity name. For example, an entity name length includes a count of the number of words that represent the entity name. In some cases, the entity name length includes a count of the number of characters in one or more of the words that represent the entity name. In some embodiments, the entity name length includes features (e.g., special characters or numbers) that distinguish among the entity names within the template-based caption when sorting entity names (e.g., to accommodate alphabetizing similar entity names).

Similarly, as used herein, the term a “template-based caption” includes or refers to a caption that follows a predefined format. For example, a template-based caption follows a rubric or a format that defines relative locations, positions, or placement of entity names and other descriptive information according to an insight template (e.g., template-based framework). In some cases, the template-based caption incorporates an entity name as a proper noun following a specific keyword or within a specific clause. In some cases, the insight augmentation system utilizes a variety of caption types that include or refer to a category or label associated with a template-based caption and that defines the structure of the template-based caption. In certain embodiments, different caption types correspond to different formats, structures, or insight templates.

As used herein, the term “placeholder name” includes or refers to a temporary or intermediate name or pseudonym used in place of a specific term, entity name, or value in a template-based caption. For example, a placeholder name is used as an intermediary to facilitate the generation of insights from the template-based caption. In some cases, a placeholder name includes multiple components, such as one or more of content to delineate or delimit the placeholder name (e.g., an entity name designator), content from an initial/original entity name, and an entity name count.

Relatedly, as used herein, the term “placeholder rubric” includes or refers to naming convention for and/or the placement of placeholder pairs within a renaming map. For example, the placeholder rubric includes a convention defining the placement of an extracted term from the entity name between an entity name designator and an entity name count. For instance, the placeholder rubric includes a convention defining an order for the relative placement of terms within a placeholder name—e.g., entity name designator followed by an extracted term from the entity name followed by an entity name count (e.g., a consecutively numbered occurrence of a new entity name). In some cases, the placeholder rubric includes a convention defining the placement of terms within a placeholder name that utilizes a truncated word from the entity name as the extracted term, or excludes one or more words the entity name, or generates new content to replace the entity name.

Furthermore, as used herein, the term “renaming map” includes or refers to a data structure mapping between entity names and placeholder names. In particular, a renaming map includes placeholder pairs associating entity names with placeholder names. In some cases, the insight augmentation system organizes the renaming map in an order based on the length of the entity names. In some embodiments, a renaming map thus provides an order and a structure for replacing entity names with placeholder names (and vice-versa) in a caption. In some cases, the insight augmentation system maps the entity names to placeholder names within the renaming map in an order defined by the entity list. For example, based on the renaming map, the insight augmentation system replaces the entity names with placeholder names according to the entity name lengths to generate a modified caption.

As used herein, the term “large language model” includes or refers to a computer algorithm or a collection of computer algorithms that can be trained and/or tuned based on inputs to approximate unknown functions. For example, a large language model can include a computer algorithm with branches, weights, or parameters that change based on training data to improve for a particular task. Thus, a large language model can utilize one or more learning techniques (e.g., supervised or unsupervised learning) to improve in accuracy and/or effectiveness. Example large language models include various types of decision trees (e.g., gradient boost models), support vector machines, Bayesian networks, random forest models, or neural networks (e.g., deep neural networks, generative adversarial neural networks, convolutional neural networks, recurrent neural networks, or diffusion neural networks).

In one or more embodiments, a large language model includes a neural network. As used herein, a “neural network” includes or refers to a model of interconnected artificial neurons (e.g., organized in layers) that communicate and learn to approximate complex functions and generate outputs (e.g., distilled placeholder insights) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a transformer neural network, a recurrent neural network (e.g., an LSTM), a graph neural network, or a generative adversarial neural network.

Along these lines, the large language models are trained and/or fine-tuned based on a diverse text corpora to perform natural language processing tasks, such as text generation, translation, summarization, and question answer generation. For example, the large language models, consist of layers of interconnected artificial neurons organized in encoder and decoder blocks, which learn complex language patterns to generate textual content. For example, the large language models include models such as Vicuna, GPT (Generative Pre-trained Transformer), BERT (Bidirectional Encoder Representations from Transformers), T5 (Text-To-Text Transfer Transformer), LLAMA, or similar architectures that utilize self-attention mechanisms in natural language understanding and generation.

As used herein, the term “placeholder insight” includes or refers to an insight generated by a large language model to paraphrase a caption. For example, a placeholder insight includes an insight generated by a large language model to paraphrase a caption describing a data chart or graph in natural language. In some cases, a placeholder insight paraphrases a caption describing a data chart or graph in natural language utilizing placeholder names. To illustrate, placeholder insights include insights for line graphs, bar graphs, pie charts, tabular data, conversions, production, clicks, average values, and other types specific to different data formats, descriptions, or attributes represented in the data. Relatedly, the term “distilled placeholder insight” includes or refers to a placeholder insight generated by a distilled insight model.

Furthermore, the term “augmented insight” includes or refers to a description utilizing natural language. For example, an augmented insight describes a data chart or graph in natural language. To illustrate, in some cases, the insight augmentation system utilizes a renaming map to replace placeholder names in a placeholder insight to generate the augmented insight. For example, the insight augmentation system replaces one or more instances of a particular placeholder name in the placeholder insight with the corresponding entity name to generate the augmented insight. In some cases, the insight augmentation system replaces one or more placeholder names (corresponding to different entity names) in the placeholder insight with associated entity names to generate the augmented insight.

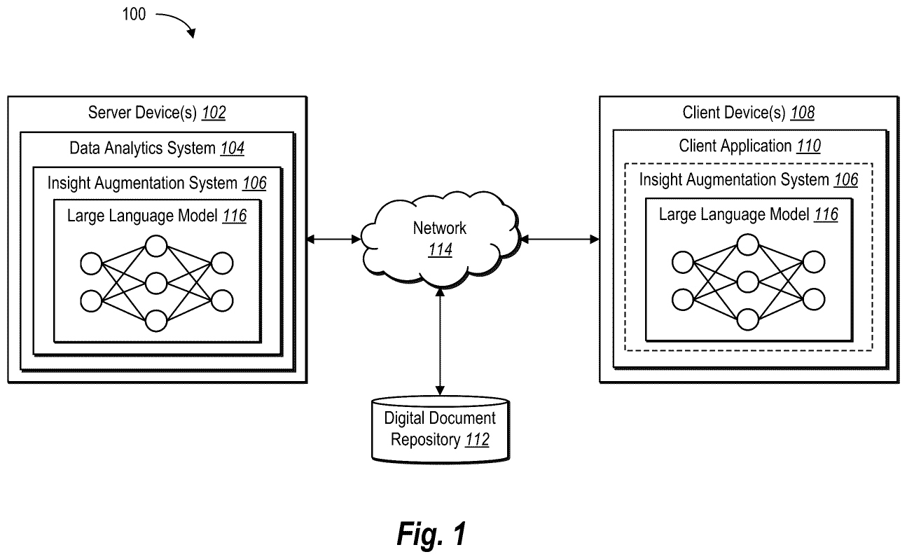

Additional detail regarding the insight augmentation system will now be provided with reference to the figures. For example, FIG. 1 illustrates a schematic diagram of an example system environment for implementing an insight augmentation system 106 in accordance with one or more embodiments. An overview of the insight augmentation system 106 is described in relation to FIG. 1. Thereafter, a more detailed description of the components and processes of the insight augmentation system 106 is provided in relation to the subsequent figures.

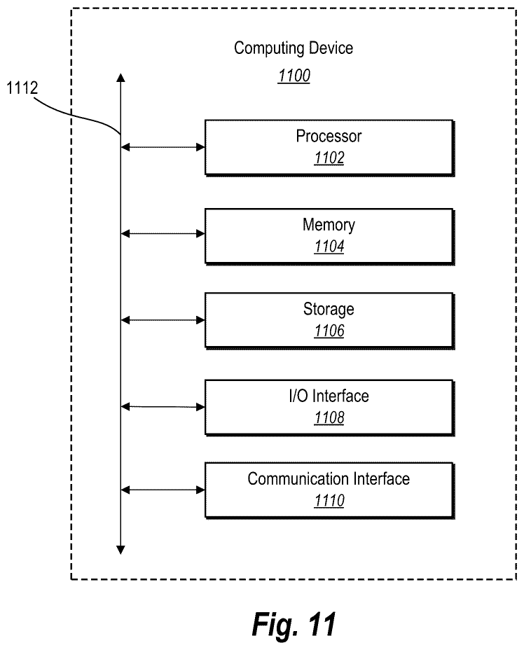

As shown, the environment 100 includes server device(s) 102, client device(s) 108, digital document repository 112, and a network 114. Each of the components of the environment communicate via the network 114, and the network 114 is any suitable network over which computing devices communicate. Example networks are discussed in more detail below in relation to FIG. 11.

As mentioned, the environment 100 includes a client device(s) 108. The client device(s) 108 is one of a variety of computing devices, including a smartphone, a tablet, a smart television, a desktop computer, a laptop computer, a virtual reality device, an augmented reality device, or another computing device as described in relation to FIG. 11. The client device(s) 108 communicates with the server device(s) 102 via the network 114. For example, the client device(s) 108 provides information to server device(s) 102 indicating client device interactions (e.g., selections of options to generate placeholder insights or other input) and receives information from the server device(s) 102 such as captions and insights. Thus, in some cases, the insight augmentation system 106 on the server device(s) 102 provides and receives information based on client device interaction via the client device(s) 108.

As shown in FIG. 1, the client device(s) 108 includes a client application 110. In particular, the client application 110 is a web application, a native application installed on the client device(s) 108 (e.g., a mobile application, a desktop application, etc.), or a cloud-based application where all or part of the functionality is performed by the server device(s) 102. Based on instructions from the client application 110, the client device(s) 108 presents or displays information to a user, including captions, data charts, graphs, placeholder insights, distilled placeholder insights, augmented insights, and/or selectable options for generating insights. In some cases, the client application 110 includes all or part of the insight augmentation system 106 and/or the large language model 116.

As illustrated in FIG. 1, the environment 100 includes the server device(s) 102. The server device(s) 102 generates, tracks, stores, processes, receives, and transmits electronic data, such as captions, distilled placeholder insights, placeholder insights, data charts, and/or generated augmented insights. For example, the server device(s) 102 receives data from the client device(s) 108 in the form of an indication of a client device interaction to generate an augmented insight from a caption. In response, the server device(s) 102 transmits data to the client device(s) 108 to cause the client device(s) 108 to display or present an augmented insight based on the client device interaction.

In some embodiments, the server device(s) 102 communicates with the client device(s) 108 to transmit and/or receive data via the network 114, including client device interactions, caption editing requests, digital images of graphs or charts, and/or other data. In some embodiments, the server device(s) 102 comprises a distributed server where the server device(s) 102 includes a number of server devices distributed across the network 114 and located in different physical locations. The server device(s) 102 comprise a content server, an application server, a communication server, a web-hosting server, a multidimensional server, a container orchestration server, or a machine learning server. The server device(s) 102 further access and utilize the digital document repository 112 to store and retrieve information such as stored data charts, captions, training data, synthesized training data, distilled placeholder insights, placeholder insights, augmented insights, and/or other data.

As further shown in FIG. 1, the server device(s) 102 also includes the insight augmentation system 106 as part of a data analytics system 104. For example, in one or more implementations, the data analytics system 104 is able to store, generate, modify, edit, enhance, provide, distribute, and/or share digital content, such as captions and insights. For example, the data analytics system 104 provides tools for the client device(s) 108, via the client application 110, to generate augmented insights utilizing the large language model 116.

In one or more embodiments, the server device(s) 102 includes all, or a portion of, the insight augmentation system 106. For example, the insight augmentation system 106 operates on the server device(s) 102 to generate and provide augmented insights. In some cases, the insight augmentation system 106 utilizes, locally on the server device(s) 102 or from another network location (e.g., the digital document repository 112), a large language model 116 to generate augmented insights. In addition, the insight augmentation system 106 includes or communicates with other models, such as a natural language model, for implementation and training.

In certain cases, the client device(s) 108 includes all or part of the insight augmentation system 106. For example, the client device(s) 108 generates, obtains (e.g., downloads), or utilizes one or more aspects of the insight augmentation system 106 from the server device(s) 102. Indeed, in some implementations, as illustrated in FIG. 1, the insight augmentation system 106 is located in whole or in part on the client device(s) 108. For example, the insight augmentation system 106 includes a web hosting application that allows the client device(s) 108 to interact with the server device(s) 102. To illustrate, in one or more implementations, the client device(s) 108 accesses a web page supported and/or hosted by the server device(s) 102.

In one or more embodiments, the client device(s) 108 and the server device(s) 102 work together to implement the insight augmentation system 106. For example, in some embodiments, the server device(s) 102 train one or more neural networks (e.g., the large language model 116) discussed herein and provide the one or more neural networks to the client device(s) 108 for implementation. In some embodiments, the server device(s) 102 train one or more neural networks, the client device(s) 108 requests augmented insights, and the server device(s) 102 generate augmented insights utilizing the one or more neural networks. Furthermore, in some implementations, the client device(s) 108 assists in training one or more neural networks.

Although FIG. 1 illustrates a particular arrangement of the environment 100, in some embodiments, the environment 100 has a different arrangement of components and/or may have a different number or set of components altogether. For instance, as mentioned, the insight augmentation system 106 is implemented by (e.g., located entirely or in part on) the client device(s) 108. In addition, in one or more embodiments, the client device(s) 108 communicates directly with the insight augmentation system 106, bypassing the network 114. Further, in some embodiments, the large language model 116 includes one or more components stored in the digital document repository 112, maintained by the server device(s) 102, the client device(s) 108, or a third-party device.

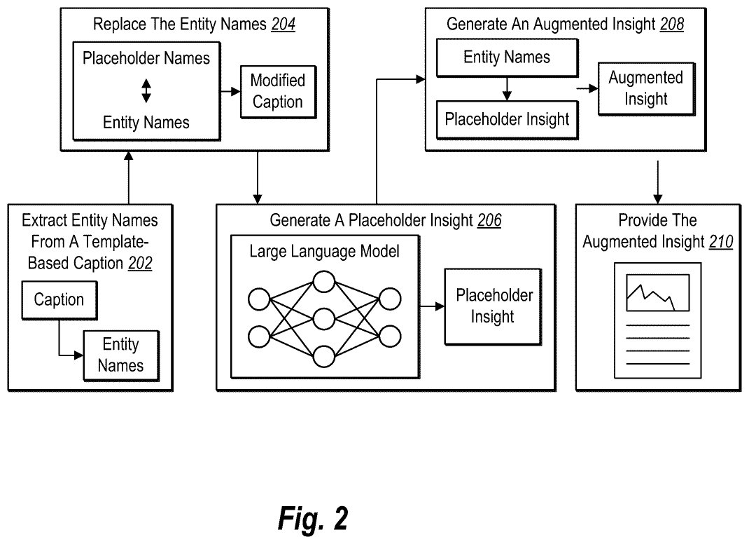

As mentioned, in one or more embodiments, the insight augmentation system 106 generates and provides augmented insights for template-based captions using a large language model distilled from a natural language model. The insight augmentation system 106 can generate an insight even for complex data or a complex caption that includes multi-word entity names that would otherwise confuse or cause errors in prior systems. FIG. 2 illustrates an example overview of an insight augmentation algorithm utilizing a large language model to generate an augmented insight for complex-entity-related data illustrated in a graph or chart in accordance with one or more embodiments. Additional detail regarding the various acts illustrated in FIG. 2 is provided thereafter with reference to subsequent figures.

As illustrated in FIG. 2, the insight augmentation system 106 performs an act 202 to extract entity names from a template-based caption. In particular, the insight augmentation system 106 extracts an entity name from a template-based caption describing a data chart or data graph. For example, the insight augmentation system 106 identifies and isolates an entity name indicating proper or improper nouns such as names of people, organizations, locations, dates, and other specific terms. In some cases, an entity name incorporates multiple consecutive words to indicate the entity name. In some cases, the insight augmentation system 106 utilizes pre-defined or user-designated entity names.

Similarly, in one or more embodiments, a template-based caption follows a predefined format. For example, a template-based caption follows a rubric or a format that defines relative locations, positions, or placement of entity names and other descriptive information according to an insight template. In some cases, the insight augmentation system 106 utilizes a variety of caption types that include or refer to a category or label associated with a template-based caption and that defines the structure of the template-based caption. In certain embodiments, different caption types correspond to different formats, structures, or insight templates. In some cases, template-based captions include multiple entity names that each include multiple consecutive words.

As further illustrated in FIG. 2, the insight augmentation system 106 performs an act 204 to replace entity names. For example, the insight augmentation system 106 generates a modified caption from the template-based caption by replacing the entity names within the template-based caption with placeholder names. For example, the insight augmentation system 106 replaces each instance of a particular entity name with an instance of a particular placeholder name.

For example, the insight augmentation system 106 generates a modified caption from the template-based caption by replacing the entity names with placeholder names utilizing a renaming map. In some embodiments, a placeholder name is used as a temporary or intermediate name or pseudonym used in place of a specific term, entity name, or value in a template-based caption. For example, the insight augmentation system 106 utilizes a placeholder name as an intermediary to facilitate the generation of insights from the template-based caption. In some cases, a placeholder name includes multiple components, such as: 1) content to delineate or delimit the placeholder name (e.g., an entity name designator), 2) content from an initial/original entity name, and 3) an entity name count.

In some embodiments, a renaming map includes or refers to a data structure mapping between entity names and placeholder names. In particular, a renaming map includes placeholder pairs associating entity names with placeholder names. In some cases, the insight augmentation system organizes the renaming map in an order based on the length of the entity names. In some embodiments, a renaming map thus provides an order and a structure for replacing entity names with placeholder names (and vice-versa) in a caption.

In some embodiments, the insight augmentation system 106 generates an entity list that includes the entity names from the template-based caption sorted according to entity name lengths. Furthermore, the insight augmentation system 106 maps the entity names to placeholder names within the renaming map. In some cases, the insight augmentation system 106 maps the entity names to placeholder names within the renaming map in an order defined by the entity list. Based on the renaming map, the insight augmentation system 106 replaces the entity names with placeholder names according to the entity name lengths to generate a modified caption. In some embodiments, a modified caption includes or refers to a caption that has been altered from its original form. In some cases, a modified caption includes a template-based caption that has been adjusted by substituting specific proper nouns, names, entity names, or identifiers with placeholder names.

Additionally, in some embodiments, the insight augmentation system 106 performs an act 206 to generate a placeholder insight. For example, the insight augmentation system 106 provides a modified caption to the large language model. Based on the modified caption, the large language model generates the placeholder insight incorporating the placeholder names. For example, the insight augmentation system 106 utilizes the large language model to generate a placeholder insight paraphrasing the caption to describe the data chart or graph in natural language utilizing the placeholder names. Indeed, by incorporating the placeholder names into the modified caption, the insight augmentation system 106 generates placeholder insights from template-based captions efficiently and accurately. Accordingly, in some embodiments, the insight augmentation system utilizes the large language model to paraphrase or summarize the template-based caption with a high degree of accuracy and with more natural phrasing than is achievable using prior systems

As mentioned, in certain embodiments, the insight augmentation system distills (or transfers knowledge of) a natural language model into a distilled insight model (e.g., a neural network with a small fraction of the parameters of the natural language model). For example, the insight augmentation system utilizes a supervised distillation process to transfer knowledge of the natural language model into a distilled insight model by tuning parameters of the distilled insight model to replicate or approximate predictions of the natural language model. In some cases, the insight augmentation system 106 performs the act 206 utilizing the distilled insight model to generate a distilled placeholder insight.

Furthermore, in some embodiments, the insight augmentation system 106 performs act 206 to generate placeholder insights of a variety of types. For example, the insight augmentation system 106 generates the placeholder insights by paraphrasing from among multiple types of template-based captions. By paraphrasing multiple types of template-based captions, the insight augmentation system 106 generates placeholder insights that include insights for line graphs, bar graphs, pie charts, tabular data, conversions, production, clicks, average values, and other types specific to different data formats, descriptions, or attributes represented in the data.

Based on the type of template-based caption used, the insight augmentation system 106 generates associated placeholder insights that include line graph insights, bar graph insights, pie chart insights, tabular data insights, conversion insights, production insights, click insights, insights describing an average value, and/or other insight types specific to data formats, descriptions, and/or attributes reflected by the data. The insight augmentation system 106 thus accurately generates an insight type corresponding to the template-based caption.

As further illustrated in FIG. 2, the insight augmentation system 106 performs an act 208 to generate an augmented insight. For example, the insight augmentation system 106 generates an augmented insight describing the data chart or graph in natural language by replacing the placeholder names in the placeholder insight with the entity names. In some cases, the insight augmentation system 106 utilizes the renaming map to replace the placeholder names in the placeholder insight with the entity names according to a length-based order of a sorted list. For example, the insight augmentation system 106 replaces one or more instances of a particular placeholder name in the placeholder insight with the corresponding entity name. In some cases, the insight augmentation system 106 replaces one or more placeholder names (corresponding to different entity names) in the placeholder insight with associated entity names.

Additionally, the insight augmentation system 106 performs an act 210 to provide the augmented insight for display. For example, the insight augmentation system 106 performs an act 210 to provide the augmented insight for display on a client device. Indeed, the insight augmentation system 106 generates an insight generation interface for utilizing a large language model to paraphrase a depicted graph or chart.

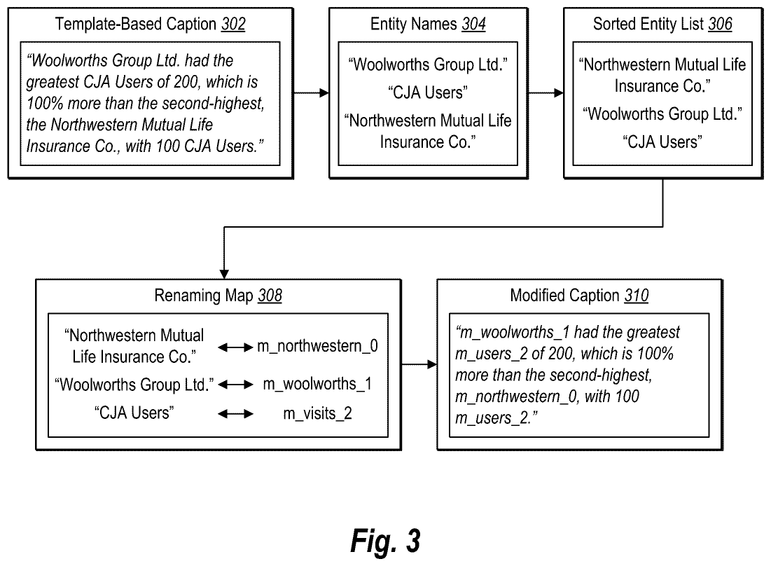

In one or more embodiments, the insight augmentation system 106 performs a step for generating an augmented insight describing a data chart in natural language phrases. The above description of the acts 202-208, including the supporting description of FIGS. 3-4, provide structure and support for acts and algorithms of performing a step for generating an augmented insight describing a data chart in natural language phrases.

For instance, as part of performing a step for generating an augmented insight, the insight augmentation system 106 extracts entity names from a template-based caption (as described in act 202 and in FIG. 3). For example, the insight augmentation system 106 extracts entity names by determining a set of multiple consecutive words that define the entity name within the template-based caption and by extracting the set of multiple consecutive words from the template-based caption. The insight augmentation system 106 further generates an entity list includes the entity name and one or more additional entity names from the template-based caption, sorts the entity list according to entity name lengths, and maps (using a renaming map) the entity name to the placeholder name within the renaming map in an order defined by the entity list. In addition, the insight augmentation system 106 replaces entity names with placeholders as described in act 204 and in FIG. 3. Further, the insight augmentation system 106 generates a placeholder insight using an large language model to paraphrase a modified caption using placeholder names, as described in act 206 and FIG. 4. The insight augmentation system 106 further generates the augmented insight by replacing placeholder names with entity names, as described in act 208 and FIG. 4.

As mentioned, the insight augmentation system 106 utilizes placeholder names and large language models to paraphrase complex captions. For example, the insight augmentation system 106 generates modified captions as the basis for paraphrasing data charts and data graphs. FIG. 3 illustrates an example diagram for generating a modified caption from a template-based caption in accordance with one or more embodiments.

As depicted in FIG. 3, the insight augmentation system 106 receives or generates a template-based caption 302. In particular, the insight augmentation system 106 receives a template-based caption 302 which analyzes tabular data (e.g., data charts or data graphs) by narrating, summarizing, or explaining the tabular data in words laid out in a predicted grammatical or sentence structure. The template-based caption 302 includes a caption such as a line graph caption, bar graph caption, pie chart caption, tabular data caption, conversion caption, production caption, click caption, a caption describing an average value, and/or another caption type specific to data formats, descriptions, and/or attributes reflected by the data. For example, the template-based caption 302 includes a:
i) minimum value caption: “On [b] June 10th[/b], the number of visits was [b]30[/b], a sizeable [b]77%[/b] decrease from the average of [b]132[/b].”
ii) maximum value caption: “On [b] June 11th[/b], the visits reached their peak at [b]120[/b], which was [b]130%[/b] more than the average.”
iii) period of increase caption: “Between [b] Jun. 14, 2020[/b] and [b] Jun. 14, 2020[/b], visits surged [b]324%[/b], jumping from [b]82[/b] to [b]348[/b].”
iv) period of decrease caption: “From [b] January 26th[/b] to [b] January 26th[/b], the number of visits dropped [b]590[/b], from [b]4,484[/b] to [b]1,820[/b].”
v) periodic cycle caption: “Every [b]24[/b] hours, there is a cyclic pattern where the highest number of visits happen at [b]6[/b]o'clock and the lowest at [b]14[/b].”
vi) upward trend caption: “From [b]16:00[/b] to [b]16:00[/b], the average totalhb increased by [b]412[/b] per time-step, going from [b]82,515.24[/b] to [b]96,945.74[/b] in total.”
vii) downward trend caption: “Over the period from [b] January 7th[/b] to [b] Febuary 1st[/b], visits decreased on average by [b]-2[/1] per time-step, falling from [b]10,700[/b] to [b]9,372[/b] in total.”
viii) anomaly detection caption: “[b]5[/b] days—[b] June 8th[/b], [b] June 10th[/b], [b] June, 14th[/b], and [b] June 15th[/b]—saw abnormal numbers of visits, with a sizeable [b]296%[/b] difference from the average of that period.”

To elaborate, in some embodiments, the template-based caption 302 includes multiple instances of entity names, complex entity names, and complicated sentence structures. Notably, the insight augmentation system 106 utilizes complex template-based captions such as: “Woolworths Group Ltd. had the greatest CJA Users of 200, which is 100% more than the second-highest, the Northwestern Mutual Life Insurance Co., with 100 in CJA Users. Compared to the previous period, Woolworths Group Ltd. had a 0% decrease in CJA Users.” In contrast, simple template-based captions that are successfully paraphrased by prior systems are less complicated with more limited information such as: “On Oct. 13, 2020, the number of visits reached a peak of 11,974,677, which was 67% higher than the average for this period.”

As also shown, the insight augmentation system 106 extracts entity names 304 from the template-based caption 302. In particular, the insight augmentation system 106 extracts one or more entity names for the entity names 304 which include multiple consecutive words that define each entity name within the template-based caption. In some embodiments, the insight augmentation system 106 utilizes insight templates (e.g., template-based frameworks) of the template-based captions to extract the entity names 304. For example, the insight augmentation system 106 utilizes formats of the various types of template-based captions to extract the entity names 304. In the example shown, the insight augmentation system 106 extracts the entity names “Woolworths Group Ltd.,” “CJA Users,” and “Northwestern Mutual Life Insurance Co.”

To illustrate, the insight augmentation system 106 analyzes the modified caption 402 by breaking down the modified caption 402 into component parts, such as nouns, verbs, adjectives, and other parts of speech. In some cases, the insight augmentation system 106 utilizes algorithms or neural networks to identify sentence structures, including subject-verb-object relationships, to recognize entity names 304 such as “Woolsworths Group Ltd.” and “CJA Users” (grouping words that function together as a single unit). In some embodiments, the insight augmentation system 106 utilizes attention mechanisms to focus on certain words within the modified caption 402 to understand how they relate to each other. For instance, when the insight augmentation system 106 evaluates the modified caption 402 utilizing attention mechanisms, the attention heads highlight the word groupings of “Woolsworths Group Ltd.” and “CJA Users” among the entity names 304.

Furthermore, the insight augmentation system 106 generates a sorted entity list 306. For example, the insight augmentation system 106 generates a list of the entity names 304 extracted from the template-based caption 302. In addition, the insight augmentation system sorts the entity names 304. For example, the insight augmentation system 106 populates the sorted entity list 306 with the entity names 304 extracted from the template-based caption 302. Furthermore, in some embodiments the insight augmentation system 106 organizes the list by sorting the sorted entity list 306 such that the entity names 304 are extracted from the template-based caption 302 based on the length of the entity names 304. To illustrate, as shown in FIG. 3, the insight augmentation system 106 extracts the entity names 304 of “Woolworths Group Ltd.,” “CJA Users,” and “Northwestern Mutual Life Insurance Co” and sorts the entity names 304 according to entity name length to generate the sorted entity list 306 of “Northwestern Mutual Life Insurance Co,” “Woolworths Group Ltd.,” and “CJA Users.” In some embodiments, the insight augmentation system 106 generates the sorted entity list 306 such that longer entity names are placed higher (or before) shorter entity names (longest name first, shortest name last).

To elaborate, in some embodiments, the insight augmentation system 106 utilizes the sorted entity list 306 to ensure an accurate replacement or substitution of the entity names 304 within the template-based caption 302. For example, consider an example situation where the template-based caption 302 includes three entity names listed within a caption in the order of “Users,” “Admin,” and “CJA Users.” Without sorting the three entity names, a system could replace the entity name “Users” first and also replace the “Users” sub-string within “CJA Users” before replacing the entity name “CJA Users.” In this case, it is possible that a system incorrectly replaces a portion of the longer entity name “CJA Users” (e.g., “Users”) before attempting to replace the entire name “CJA Users.” In contrast, by sorting the entity names 304 and generating the sorted entity list 306, the insight augmentation system 106 ensures that the longer entity names will be replaced before the shorter names (e.g., shorter names potentially equivalent to partial longer entity names) are replaced.

As also depicted in FIG. 3, the insight augmentation system 106 generates a renaming map 308. In some cases, the insight augmentation system 106 generates the renaming map 308 by generating simplified (e.g., intermediate or placeholder) names corresponding to the entity names 304 as the placeholder names. For example, the insight augmentation system 106 generates, from the sorted entity list 306, the renaming map 308 as a structure mapping the association between the entity names 304 and the placeholder names. In some cases, the insight augmentation system 106 generates the renaming map 308 by populating the renaming map 308 with placeholder pairs, where a placeholder pair includes an entity name and a corresponding placeholder name. In some embodiments, the insight augmentation system 106 adds the placeholder pairs to the renaming map 308 based on an order of the entity names 304 defined by the sorted entity list 306.

In some embodiments, the insight augmentation system 106 generates placeholder names using a placeholder rubric that defines the naming convention for and/or the placement of placeholder pairs (e.g., entity names 304 and/or placeholder names) within the renaming map 308. For example, the insight augmentation system 106 generates a placeholder name corresponding to an entity name by generating a placeholder rubric defining placement of an extracted term from the entity name between an entity name designator and an entity name count. For instance, the insight augmentation system 106 generates a placeholder rubric that defines an order relative placement of terms within a placeholder name—e.g., entity name designator followed by an extracted term from the entity name followed by an entity name count (e.g., a consecutively numbered occurrence of a new entity name).

In some cases, the insight augmentation system 106 populates the rubric with the longest word of the entity name as the extracted term. In some cases, the insight augmentation system 106 populates the rubric with a truncated word from the entity name as the extracted term. In particular, the insight augmentation system 106 generates simplified names for the placeholder names by utilizing part of the entity names 304 and excluding one or more words from entity names 304.

To illustrate, in the example shown in FIG. 3, the insight augmentation system 106 generates the renaming map 308 with placeholder pairs. As shown, the insight augmentation system 106 generates placeholder pairs associating or mapping entity names 304 to placeholder names such as: “Northwestern Mutual Life Insurance Co” to “m_northwestern_0,” “Woolworths Group Ltd.” to “m_woolsorths_1,” and “CJA Users” to “m_users_2.” In some cases, the insight augmentation system 106 utilizes the entity name designator of “m” (or some other special-purpose delimiter character) to designate the placeholder names. By utilizing the entity name designator, in some embodiments, the insight augmentation system 106 enables and/or trains the distilled language model and the natural language model to recognize the placeholder names as entity names during inference. In some cases, the insight augmentation system 106 utilizes the entity name count (e.g., 0, 1, 2, etc.) to ensure each of the entity names 304 are assigned different placeholder names (e.g., generate distinct placeholder names when multiple entities have the same longest or truncated word).

Additionally, the insight augmentation system 106 generates a modified caption 310. For example, the insight augmentation system 106 generates the modified caption 310 from the template-based caption 302 by replacing the entity names 304 with the placeholder names utilizing the renaming map 308. In some case, the insight augmentation system 106 replaces the entity names within the template-based caption 302 by replacing the entity names 304 with the placeholder names based on the order of the entity names within the renaming map 308 and/or the sorted entity list 306 (e.g., replacing longest entity names first and iteratively replacing progressively shorter entity names until all entity names are replaced).

In some embodiments, the insight augmentation system 106 replaces one or more of the entity names 304 with placeholder names utilizing the renaming map 308. To illustrate, the insight augmentation system 106 replaces a first instance of an entity name within the template-based caption 302 with the placeholder name and replaces a second instance of the same entity name within the template-based caption 302 with the same placeholder name (and similarly for a third instance, fourth instance, etc.). Similarly, the insight augmentation system 106 replaces a first entity name within the template-based caption 302 with a first placeholder name and replaces a second entity name within the template-based caption 302 with a second placeholder name (and similarly for a third entity name, fourth entity name, etc.).

As mentioned, the insight augmentation system 106 efficiently and accurately generates augmented insights from a variety of complex captions utilizing the modified captions. In particular, the insight augmentation system 106 utilizes a large language model to generate a placeholder insight from a modified caption, and the insight augmentation system 106 further generates an augmented insight from the placeholder insight. FIG. 4 illustrates an example diagram for generating an augmented insight from a modified caption in accordance with one or more embodiments.

As depicted in FIG. 4, the insight augmentation system 106 provides the modified caption 402 to the large language model 404. As mentioned, the large language model 404 is the is trained to understand placeholder names. In some cases, as described in more detail below in relation to FIG. 6, the insight augmentation system 106 distills knowledge from a natural language model into a distilled insight model to tune the large language model 404 (e.g., the distilled insight model) to replicate or imitate predictions of a natural language model using far fewer parameters.

In some embodiments, the large language model 404 includes or refers to a machine learning model trained to perform computer tasks to generate textual content (e.g., placeholder insights). For example, the insight augmentation system 106 utilizes a large language model 404 that includes a large number of parameters and neurons (e.g., 100+ billion parameters). In some cases, the large language model 404 includes or refers to a neural network that includes fewer than a threshold number of parameters (e.g., fewer than 500 million parameters or fewer than 100 million parameters) and that generates predicted outputs based on input data and a text prompt (e.g., a distilled insight model). In certain embodiments, a large language model 404 has less than a threshold percentage or ratio of parameters compared to a natural language model. In some cases, the insight augmentation system 106 tunes parameters of the large language model 404 (e.g., Flan-T5 Small) using a supervised tuning process based on placeholder insights.

As depicted in FIG. 4, the insight augmentation system 106 generates the placeholder insight 406 from the modified caption 402. For example, the insight augmentation system 106 generates, utilizing the large language model 404 to process the modified caption 402, the placeholder insight 406 paraphrasing the modified caption 402 to describe the data chart or data graph in natural language using placeholder names. In particular, the insight augmentation system 106 utilizes the large language model 404 to paraphrase the modified caption 402 into a natural language insight while preserving or paraphrasing other contextual or descriptive information originally in the modified caption 402 or reflected in the corresponding data chart or graph.

For example, the insight augmentation system 106 transforms the formal or fixed language of the modified caption 402 into a more natural, fluid, and conversational style. In some cases, the insight augmentation system 106 utilizes sentences that are varied in structure (using different grammatical constructs to convey the same message), employs synonyms, and diverse phrases to avoid repetition and provide the placeholder insight 406. To illustrate, as shown in the example for FIG. 4, the insight augmentation system 106 receives the modified caption 402 of “m_woolworths_1 had the greatest m_users_2 of 200, which is 100% more than the second-highest, m_northwestern_0, with 100 in m_users_2.” In turn, the insight augmentation system 106 utilizes the large language model 404 to generate the placeholder insight 406 of “The highest m_visits_2 were for the m_woolworths_1, which had 200, 100% more than the second-highest, m_northwestern_0, with 100 in m_visits_2.” By generating the placeholder insight 406 from the modified caption 402 (as opposed to an unmodified caption with original entity names), the insight augmentation system 106 more accurately paraphrases data of a chart or graph compared to prior systems. Indeed, as described, models of prior systems (and/or the large language model 404) generate inaccurate insights or paraphrases when processing captions with complex entity names.

In some embodiments, the insight augmentation system 106 generates an augmented insight 408 from the placeholder insight 406. For example, the insight augmentation system 106 replaces one or more placeholder names with entity names utilizing a renaming map. To illustrate, the insight augmentation system 106 replaces a first instance of a placeholder name within the placeholder insight 406 with the associated entity name and replaces a second instance of the same placeholder name within the placeholder insight 406 with a modified version of the associated entity name (and similarly for a third instance, fourth instance, etc.). Similarly, the insight augmentation system 106 replaces a first placeholder name within the placeholder insight 406 with a first entity name and replaces a second placeholder name within the placeholder insight 406 with a second entity name (and similarly for a third placeholder name, fourth placeholder name, etc.).

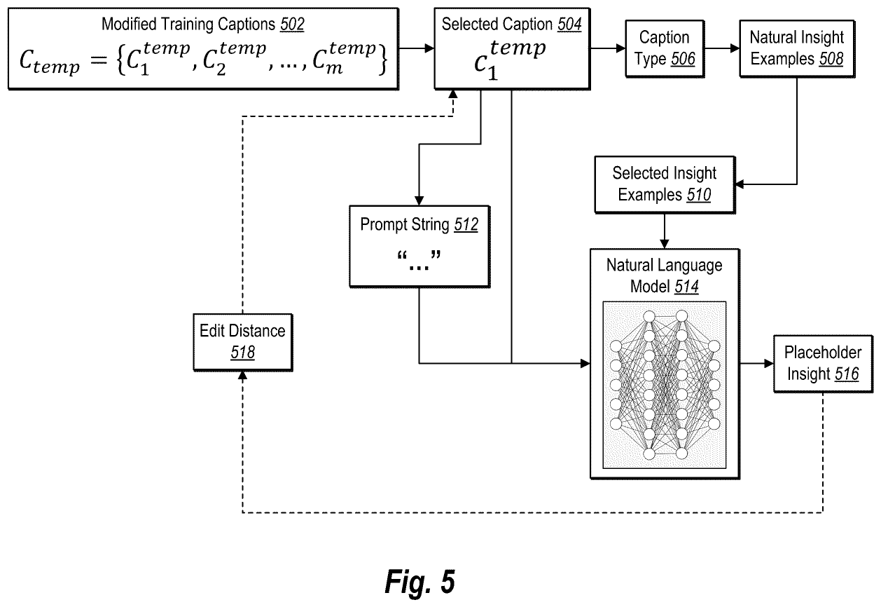

In certain embodiments, the insight augmentation system 106 prompts a natural language model (e.g., a large language model) to generate placeholder insights to use for generating augmented insights. In some cases, the insight augmentation system utilizes a natural language model that includes a large number of parameters and neurons (e.g., 100+ billion parameters) to generate a placeholder insight from a template-based training caption. FIG. 5 illustrates an example diagram for prompting a natural language model to generate a placeholder insight in accordance with one or more embodiments.

As illustrated in FIG. 5, the insight augmentation system 106 generates modified training captions 502. In one or more embodiments, the insight augmentation system 106 generates the modified training captions 502 from a set of template-based training captions. In particular, the insight augmentation system 106 generates or receives template-based training captions for analyzing tabular data (or data charts) to narrate, summarize, or explain the tabular data in words laid out in a predicted grammatical or sentence structure. In some cases, the insight augmentation system 106 utilizes template-based training captions of various caption types.

To inform or prompt the natural language model 514, in the insight augmentation system 106 generates the modified training captions 502 from a set of template-based captions. For example, the insight augmentation system 106 synthesizes a custom training dataset of modified training captions 502 for prompting the natural language model 514 to generate the placeholder insights 516. Similar to generating modified training captions as described above, the insight augmentation system 106 generates the modified training captions 502 from template-based training captions by replacing the entity names within the template-based training captions with placeholder names. In some cases, the insight augmentation system further provides a prompt string (e.g., “paraphrase and summarize”) that instructs or queries the natural language model 514 to generate a placeholder insight 516 for the modified training captions 502.

The insight augmentation system 106 further identifies or selects a selected caption 504 from among the modified training captions 502. As shown, the insight augmentation system 106 selects the selected caption

$${c}_{1}^{temp}$$

from the set of template-based captions Cₜₑₘₚ. In addition, the insight augmentation system 106 determines a caption type 506 for the selected caption 504. For instance, the insight augmentation system 106 determines a category associated with the selected caption 504 (e.g., a maximum value description of a line graph, a minimum value description of a bar graph, or a description of a value at a particular time within a line graph).

Based on the caption type 506, the insight augmentation system 106 further determines, receives, or generates natural insight examples 508. For example, the insight augmentation system 106 determines, receives, or generates a set of insight examples having a particular size (e.g., ten insight examples) for the caption type 506. Indeed, the insight augmentation system 106 generates the natural insight examples 508 by generating insights (of one or more sentences) that each use different naturally worded phrasing to summarize or explain (e.g., paraphrase) the data of a corresponding caption. In some cases, the insight augmentation system 106 receives the natural insight examples 508 from an administrator device that receives input for manually generating the natural insight examples 508 according to the caption type 506.

As further illustrated in FIG. 5, the insight augmentation system 106 identifies or selects selected insight examples 510. More specifically, the insight augmentation system 106 selects or determines the selected insight examples 510 from the natural insight examples 508. In some embodiments, the insight augmentation system 106 randomly selects a number of insight examples dictated by a token size permitted by a natural language model. For instance, the insight augmentation system 106 determines a maximum token size for a prompt input allowed by a natural language model and determines a number of the selected insight examples 510 based on the maximum token size (e.g., according to the average number of tokens within each natural insight example). For instance, the insight augmentation system 106 generates the selected insight examples 510 to have three examples (for a three-shot prompt) based on the Flan-T5 XXL model accepting an input prompt having a maximum of 512 tokens.

As also shown, the insight augmentation system 106 generates or receives a prompt string 512 for the selected caption 504. More particularly, the insight augmentation system 106 determines a string of tokens or characters that prompt the natural language model 514 to generate a placeholder insight 516 from the selected insight examples 510 and the selected caption 504. In some cases, the natural language model 514 includes or refers to a neural network having at least a threshold number of parameters (e.g., at least 500 million parameters or at least 1 billion parameters or at least 10 billion parameters or at least 100 billion parameters) that can generate placeholder insights in response to text prompts. For instance, a natural language model generates a predicted output in the form of a placeholder insight 516 that paraphrases a selected caption 504 by describing a data chart or a graph using natural language phrasing (e.g., in response to a text prompt of “paraphrase and summarize”). Indeed, in some embodiments, the placeholder insight 516 includes or refers to a sentence or a string of characters generated by the the natural language model 514 that explains or summarizes the modified training caption using natural language phrases incorporating placeholder names in place of entity names. Example natural language models in include GPT-3 and Flan-T5 XXL.

For instance, the insight augmentation system 106 determines (or receives from an administrator device) a prompt string (e.g., “paraphrase and summarize”) that triggers the natural language model 514 to generate a predicted output in the form of the placeholder insight 516. In addition, the insight augmentation system 106 inputs the prompt string 512 together with the selected caption 504 and the selected insight examples 510 into the natural language model 514. In turn, the natural language model 514 generates the placeholder insight 516 to describe or summarize a data chart corresponding to the selected caption 504 using natural language phrases and incorporating placeholder names (e.g., in place of entity names). In some cases, the insight augmentation system 106 uses a particular temperature parameter (e.g., T=0.6) for the natural language model 514 to govern the amount or degree of divergence from the selected caption 504 (e.g., where higher temperatures result in more creative predictions, and lower temperatures are less creative or more duplicative of the input).

As further illustrated in FIG. 5, in one or more embodiments, the insight augmentation system 106 determines an edit distance 518 (e.g., a Levenshtein distance) associated with the placeholder insight 516. To elaborate, the insight augmentation system 106 performs a validation loop to validate or verify the placeholder insight 516. Specifically, the insight augmentation system 106 determines an edit distance 518 as the distance between a first string (e.g., the placeholder insight 516) and a second string (e.g., the selected caption 504). In some cases, the insight augmentation system 106 determines the edit distance 518 as a number of character-level operations (e.g., token changes, such as additions, deletions, and modifications) required to convert one string to another. The insight augmentation system 106 further compares the edit distance 518 with an edit distance threshold. If the edit distance 518 satisfies the distance threshold, the insight augmentation system 106 validates the placeholder insight 516. If not, the insight augmentation system 106 repeats some or all of the steps in FIG. 5 to re-draw a set of selected insight examples, increase a temperature parameter by a small (predefined) increment (ΔT), and generate a new distilled placeholder insight using the natural language model.

In some cases, the insight augmentation system 106 also or alternatively modifies a temperature value of a distilled insight model based on the validation loop of comparing the edit distance with the edit distance threshold (e.g., for a distilled placeholder insight generated by the distilled insight model), and further uses the distilled insight model (with the new temperature parameter) to generate a new distilled placeholder insight. The insight augmentation system 106 stops the validation loop upon satisfying the distance threshold and/or reaching a threshold temperature value Tₘₐₓ.

In some embodiments, the insight augmentation system 106 iterates over the modified training captions 502 within Cₜₑₘₚ and repeats the process illustrated in FIG. 5 for each subsequent modified training caption

$$( e . g . , {c}_{2}^{temp} to {c}_{m}^{temp} ) .$$

Specifically, the insight augmentation system 106 determines the caption type 506, generates or receives the natural insight examples 508, determines selected insight examples 510, generates or receives the prompt string 512, uses the natural language model 514 to generate the placeholder insight 516, and determines the edit distance 518. Accordingly, the insight augmentation system 106 adjusts output from the natural language model 514 to generate placeholder insights for a variety of different types of modified captions and/or for a variety of different prompt strings (to then use for training a distilled insight model).

As mentioned above, in certain described embodiments, the insight augmentation system 106 utilizes a natural language model as the basis for distilling a distilled insight model. In particular, the insight augmentation system 106 prompts a natural language model to generate placeholder insights to use as training data for distilling a distilled insight model. In certain embodiments, the insight augmentation system 106 distills knowledge from a pretrained natural language model into a distilled insight model having a small fraction of the parameters of the natural language model. In particular, the insight augmentation system 106 distills a natural language model prompted to generate natural language phrases for a template-based caption into a distilled insight model for efficiently generating accurate natural language phrases for a template-based caption. FIG. 6 illustrates an example diagram for distilling a natural language model into a distilled insight model in accordance with one or more embodiments.

As illustrated in FIG. 6, the insight augmentation system 106 generates, accesses, or identifies training data 602. More specifically, the insight augmentation system 106 generates modified training captions 604 as described herein. For example, the insight augmentation system 106 generates the modified training captions 604 from template-based training captions by replacing entity names with placeholder names within the template-based training captions utilizing a renaming map. The insight augmentation system 106 also identifies a prompt string 606 (e.g., “paraphrase and summarize”) as input to prompt the natural language model 610 to generate the placeholder insight 614 and to prompt the distilled insight model 612 to generate a distilled placeholder insight 616.

In some embodiments, the insight augmentation system 106 selects modified training captions 604 (and associated template-based training captions) based on a caption type. For example, to inform or prompt the natural language model 610 and the distilled insight model 612, the insight augmentation system 106 provides the modified training captions 604 corresponding to a particular caption type. In some embodiments, the insight augmentation system 106 provides modified training captions 604 of additional caption types to train the natural language model 610 and the distilled insight model 612 to paraphrase additional types of insights. In this way, the insight augmentation system 106 thus prompts the natural language model 610 and the distilled insight model 612 to generate insights based on a caption type.

Additionally, the insight augmentation system 106 distills knowledge from a natural language model 610 prompted on the training data 602 into a distilled insight model 612. For example, the insight augmentation system 106 utilizes a natural language model 610 that includes a large number of parameters and neurons (e.g., 100+ billion parameters) to generate a placeholder insight 614 from the training data 602. In addition, the insight augmentation system 106 utilizes a distilled insight model 612 that includes fewer than a threshold number of parameters (e.g., fewer than 500 million parameters or fewer than 100 million parameters), resulting in substantial computational savings. For example, the insight augmentation system 106 utilizes the natural language model 610 to generate a placeholder insight 614 from the training data 602 (as described above) and further utilizes the distilled insight model 612 to generate a distilled placeholder insight 616 from the training data 602 as well. To elaborate, insight augmentation system 106 utilizes the distilled insight model 612 to generate the distilled placeholder insight 616 from the training data 602 using the placeholder names (as described herein).

As further illustrated in FIG. 6, the insight augmentation system 106 performs a comparison 618 as part of the distillation process. More specifically, the insight augmentation system 106 compares the placeholder insight 614 from the natural language model 610 prompted on the training data 602 to the distilled placeholder insight 616 from the distilled insight model 612 (e.g., generated from the training data 602). In some cases, the insight augmentation system 106 performs the comparison 618 by using a particular loss function (e.g., a mean squared error loss, a cross entropy loss, a distillation loss function, or some other type of loss function) to determine an error or a measure of loss between the placeholder insight 614 and the distilled placeholder insight 616.

Based on the comparison 618 (e.g., based on the measure of loss), the insight augmentation system 106 performs a parameter update 620. To elaborate, the insight augmentation system 106 updates or modifies internal network parameters of the distilled insight model 612, including weights, biases, temperatures, or other modifiable parameters. Indeed, the insight augmentation system 106 modifies parameters to reduce the measure of loss determined via the comparison 618 (e.g., to accomplish a particular distillation objective function). Repeating the process illustrated in FIG. 6 over multiple iterations or epochs, generating new predictions and performing new comparisons for parameters updates from different training data each time, the insight augmentation system 106 iteratively updates the parameters of the distilled insight model 612 until the distilled insight model 612 satisfies a threshold measure of loss (or a threshold accuracy).

Over the iterations of the training process, in some embodiments, the insight augmentation system 106 divides the training data 602 into a training set (e.g., 90% of the data) and a testing set (e.g., 10% of the data). In these or other embodiments, the insight augmentation system 106 fine tunes the distilled insight model 612 over a particular number (e.g., 20) of epochs while using a particular learning rate (e.g., 10-s). The insight augmentation system 106 further selects a fine-tuning checkpoint or iteration with the lowest test error (resulting from the comparison 618) as the version of the distilled insight model 612 to use for implementation. Thus, the insight augmentation system 106 tunes the distilled insight model 612 to generate distilled placeholder insights such that M_{dist}(Cₜₑₘₚ)→PIₙₐₜ, where M_{dist} represents the distilled insight model 612, Cₜₑₘₚ represents modified training captions, and PIₙₐₜ represents placeholder insight generated by the natural language model 610.

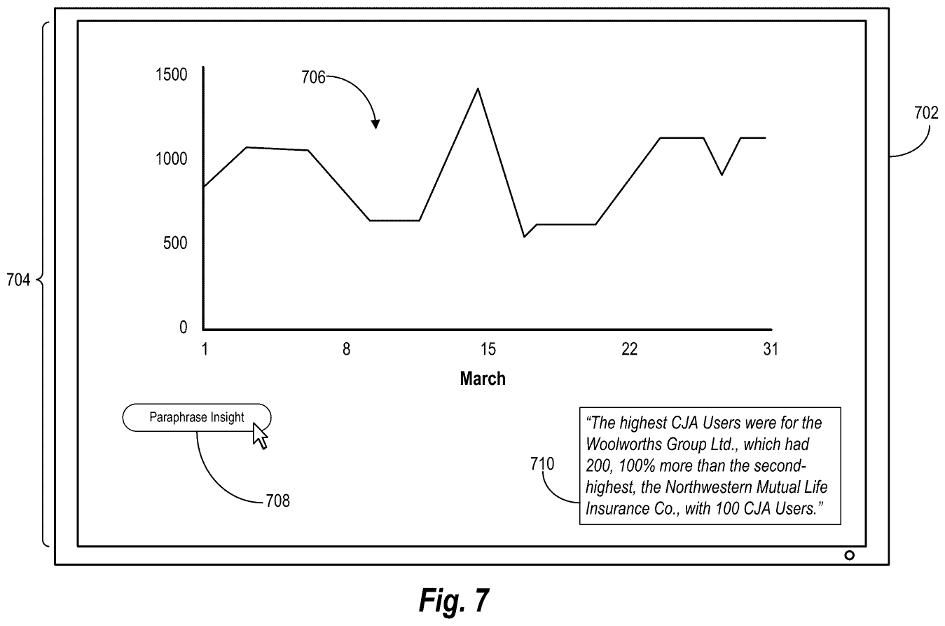

As mentioned above, in certain embodiments, the insight augmentation system 106 generates and provides placeholder insights, or distilled placeholder insights, for display on a client device. In particular, the insight augmentation system 106 utilizes a large language model to generate an insight interface for presenting a placeholder insight on a client device. FIG. 7 illustrates an example insight interface in accordance with one or more embodiments.

As illustrated in FIG. 7, the client device 702 displays an insight interface 704. As shown on FIG. 7, the insight interface 704 includes various interface elements, such as a data chart 706 (e.g., a line graph), an insight paraphrase element 708, and an augmented insight 710. Indeed, the insight augmentation system 106 receives an indication from the client device 702 of a request to generate the augmented insight 710 for the data chart 706. Particularly, the insight augmentation system 106 receives an indication of a selection of the insight paraphrase element 708 from the client device 702. In some embodiments, the insight augmentation system 106 receives the request in the form of a text query entered via a query bar within the insight interface 704.

In response to the request, the insight augmentation system 106 utilizes a large language model, or a distilled insight model, to generate to generate the augmented insight 710. More particularly, as shown in FIG. 7, the insight augmentation system 106 generates or receives a template-based caption for the data chart 706. In turn, the insight augmentation system 106 utilizes placeholder names as described herein to generate the augmented insight 710 to summarize or paraphrase a template-based caption for the data chart 706. Indeed, in some cases, the insight augmentation system 106 utilizes a distilled insight model distilled from a natural language model prompted as described herein to generate the augmented insight 710 accurately and efficiently. Additionally, the insight augmentation system 106 provides the augmented insight 710 for display within the insight interface 704 presented on the client device 702.

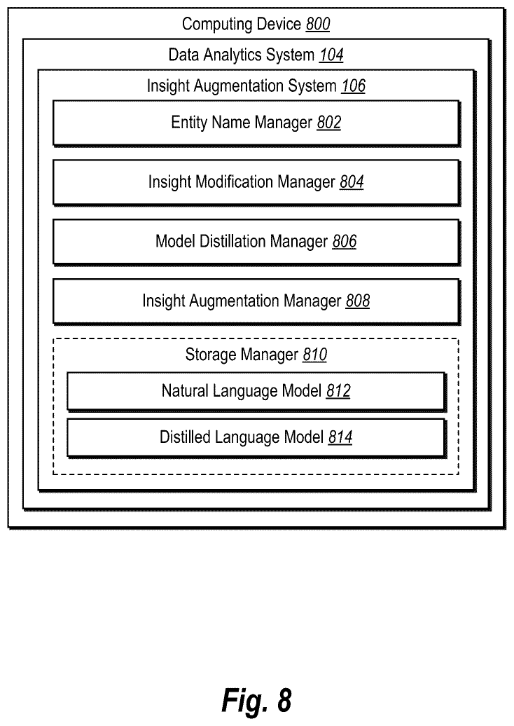

Looking now to FIG. 8, additional detail will be provided regarding components and capabilities of the insight augmentation system 106. Specifically, FIG. 8 illustrates an example schematic diagram of the insight augmentation system 106 on an example computing device 800 (e.g., one or more of the client device(s) 108 and/or the server device(s) 102). As shown in FIG. 8, the insight augmentation system 106 includes an entity name manager 802, an insight modification manager 804, a model distillation manager 806, an insight augmentation manager 808, and a storage manager 810.

As just mentioned, the insight augmentation system 106 includes the entity name manager 802. In particular, the entity name manager 802 manages, maintains, generates, determines, identifies, or extracts entity names for template-based captions. For example, the entity name manager 802 extracts entity names that include multiple consecutive words from template-based captions describing tabular data or data charts. In some cases, the entity name manager 802 associates entity names with placeholder names utilizing a renaming map. In some embodiments, based on the renaming map, the insight augmentation system 106 replaces the entity names with the placeholder names according to entity name lengths.

As also shown, the insight augmentation system 106 includes the insight modification manager 804. In particular, the insight modification manager 804 manages, maintains, generates, or determines modified captions by replacing entity names with placeholder names. For example, the insight modification manager 804 generates modified captions from template-based captions by replacing the entity names within the template-based captions with placeholder names. For example, the insight modification manager 804 replaces each instance of a particular entity name within the template-based captions with an instance of a particular placeholder name. In certain embodiments, the insight modification manager 804 manages, maintains, determines, generates, identifies, distills, tunes, trains, or prompts a large language model to generate placeholder insights to use for generating augmented insights.

As further illustrated in FIG. 8, the insight augmentation system 106 includes the model distillation manager 806. In particular, the model distillation manager 806 manages, maintains, determines, generates, identifies, distills, tunes, or trains a distilled insight model by transferring knowledge from a natural language model. Indeed, the model distillation manager 806 distills a pretrained natural language model including parameters as described herein into a distilled insight model such that the distilled insight model duplicates or imitates predictions of the natural language model.

As also shown, the insight augmentation system 106 includes the insight augmentation manager 808. In particular, the insight augmentation manager 808 manages, maintains, generates, or determines augmented insights by replacing placeholder names with entity names. For example, the insight augmentation manager 808 generates augmented insights from template-based captions by replacing the placeholder names within placeholder insights with entity names. For example, the insight augmentation manager 808 replaces each instance of a particular placeholder name within the placeholder insights with an instance of a particular entity name.

The insight augmentation system 106 further includes a storage manager 810. The storage manager 810 operates in conjunction with the other components of the insight augmentation system 106 and includes one or more memory devices, such as a natural language model 812, and a distilled insight model 814. In some cases, the storage manager 810 also stores training data, including template-based captions, data charts, and prompt queries for training one or more models described herein.

In one or more embodiments, each of the components of the insight augmentation system 106 are in communication with one another using any suitable communication technologies. Additionally, the components of the insight augmentation system 106 are in communication with one or more other devices including one or more client devices described above. It will be recognized that although the components of the insight augmentation system 106 are shown to be separate in FIG. 8, any of the subcomponents may be combined into fewer components, such as into a single component, or divided into more components as may serve a particular implementation. Furthermore, although the components of FIG. 8 are described in connection with the insight augmentation system 106, at least some of the components for performing operations in conjunction with the insight augmentation system 106 described herein may be implemented on other devices within the environment.

The components of the insight augmentation system 106 include software, hardware, or both. For example, the components of the insight augmentation system 106 include one or more instructions stored on a computer-readable storage medium and executable by processors of one or more computing devices (e.g., the computing device 800). When executed by the one or more processors, the computer-executable instructions of the insight augmentation system 106 cause the computing device 800 to perform the methods described herein. Alternatively, the components of the insight augmentation system 106 comprise hardware, such as a special purpose processing device to perform a certain function or group of functions. Additionally, or alternatively, the components of the insight augmentation system 106 include a combination of computer-executable instructions and hardware.

Furthermore, the components of the insight augmentation system 106 performing the functions described herein may, for example, be implemented as part of a stand-alone application, as a module of an application, as a plug-in for applications including content management applications, as a library function or functions that may be called by other applications, and/or as a cloud-computing model. Thus, the components of the insight augmentation system 106 may be implemented as part of a stand-alone application on a personal computing device or a mobile device. Alternatively, or additionally, the components of the insight augmentation system 106 may be implemented in any application that allows creation and delivery of content to users, including, but not limited to, applications in ADOBE® EXPERIENCE MANAGER and ADVERTISING CLOUD®, such as ADOBE ANALYTICS®, ADOBE AUDIENCE MANAGER®, and MARKETO®. “ADOBE,” “ADOBE EXPERIENCE MANAGER,” “ADVERTISING CLOUD,” “ADOBE ANALYTICS,” “ADOBE AUDIENCE MANAGER,” and “MARKETO” are either registered trademarks or trademarks of Adobe Inc. in the United States and/or other countries.

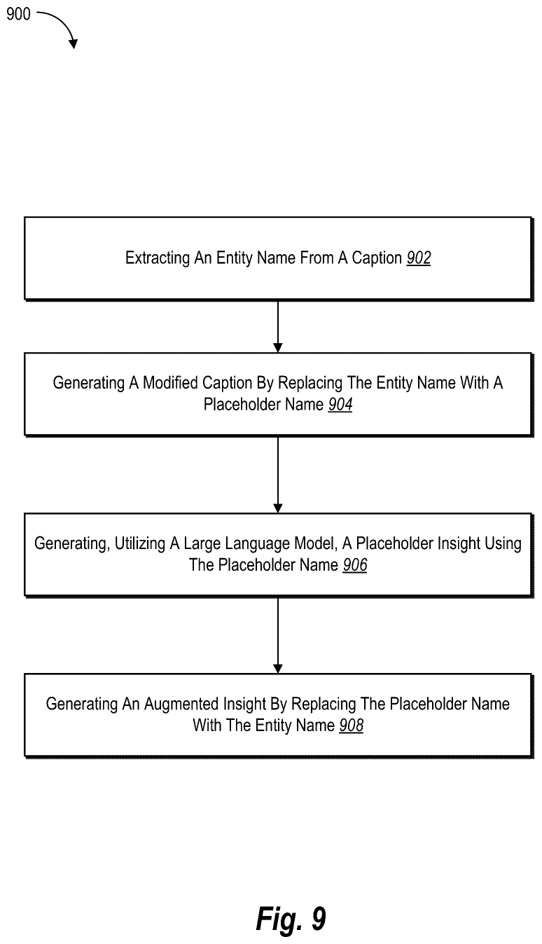

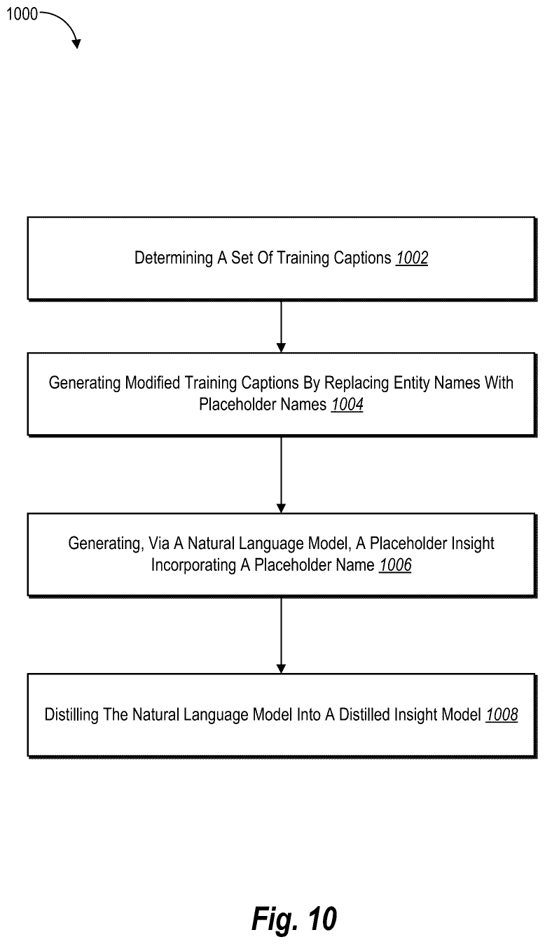

FIGS. 1-8 the corresponding text, and the examples provide a number of different systems, methods, and non-transitory computer readable media for utilizing distilled insight models distilled from natural language models to generate distilled placeholder insights for data charts. In addition to the foregoing, embodiments can also be described in terms of flowcharts comprising acts for accomplishing a particular result. For example, FIGS. 9-10 illustrate flowcharts of example sequences or series of acts in accordance with one or more embodiments.

While FIGS. 9-10 illustrate acts according to particular embodiments, alternative embodiments may omit, add to, reorder, and/or modify any of the acts shown in FIGS. 9-10. The acts of FIGS. 9-10 can be performed as part of a method. Alternatively, a non-transitory computer readable medium can comprise instructions, that when executed by one or more processors, cause a computing device to perform the acts of FIGS. 9-10. In still further embodiments, a system can perform the acts of FIGS. 9-10. Additionally, the acts described herein may be repeated or performed in parallel with one another or in parallel with different instances of the same or other similar acts.

FIG. 9 illustrates an example series of acts 900 for generating an augmented insight from a caption utilizing a distilled insight model. In particular, the series of acts 900 includes acts 902-908. For example, the act 902 includes extracting an entity name from a caption. Specifically, the act 902 involves extracting, using an insight augmentation algorithm that includes a renaming map and a large language model, an entity name from a template-based caption describing a data chart according to an insight template. The act 904 includes generating a modified caption by replacing the entity name with a placeholder name. Specifically, the act 904 involves generating, utilizing the renaming map, a modified caption from the template-based caption by replacing the entity name with a placeholder name. The act 906 includes generating, utilizing a distilled insight model, a placeholder insight using the placeholder name. Specifically, the act 906 involves generating, utilizing a large language model to process the modified caption, a placeholder insight describing the data chart in natural language using the placeholder name. The act 908 includes generating an augmented insight by replacing the placeholder name with the entity name. Specifically, the act 908 involves generating, using the insight augmentation algorithm, an augmented insight describing the data chart in natural language by replacing the placeholder name in the placeholder insight with the entity name.

In some embodiments, the series of acts 900 includes an act of determining a set of multiple consecutive words that define the entity name within the template-based caption. In these or other embodiments, the series of acts 900 includes an act of extracting the set of multiple consecutive words from the template-based caption. In certain examples, the series of acts 900 includes an act of generating an entity list that includes the entity name and one or more additional entity names from the template-based caption. In some embodiments, the series of acts 900 includes an act of sorting the entity list according to entity name lengths. In one or more embodiments, the series of acts 900 includes an act of mapping the entity name to the placeholder name within the renaming map in an order defined by the entity list.

In some cases, the series of acts 900 includes an act of mapping the entity name to the placeholder name utilizing the renaming map, wherein the placeholder name includes a longest word and excludes one or more other words from the entity name within the template-based caption. In certain embodiments, the series of acts 900 includes an act of generating the placeholder name by generating a placeholder rubric defining placement of an extracted term between an entity name designator and an entity name count. In the same or other embodiments, the series of acts 900 includes an act of populating the rubric with the longest word of the entity name as the extracted term. In some examples, the series of acts 900 includes an act of utilizing the large language model, wherein the large language model is trained to understand placeholder names.

In certain cases, the series of acts 900 includes an act of generating the modified caption from the template-based caption by replacing a second instance of the entity name with a second instance of the placeholder name utilizing the renaming map. In one or more embodiments, the series of acts 900 includes an act of generating the augmented insight by replacing a second instance of the placeholder name in the placeholder insight with the entity name. In these or other embodiments, the series of acts 900 includes an act of generating a modified caption from the template-based caption by replacing an additional entity name with an additional placeholder name utilizing the renaming map. In certain cases, the series of acts 900 includes an act of generating, utilizing the large language model to process the modified caption, the placeholder insight describing the data chart in natural language using the additional placeholder name. In some embodiments, the series of acts 900 includes an act of generating the augmented insight describing the data chart in natural language by replacing the additional placeholder name in the placeholder insight with the additional entity name.

In some embodiments, the series of acts 900 includes an act of generating a modified caption from a template-based caption describing a data chart by: sorting an entity list that includes an entity name extracted from the template-based caption according to entity name lengths; generating, from the entity list, a renaming map that maps the entity name to a placeholder name; and replacing the entity name within the template-based caption with the placeholder name.

In these or other embodiments, the series of acts 900 includes an act of generating, using a large language model to process the modified caption, a placeholder insight describing the data chart in natural language using the placeholder name. In certain examples, the series of acts 900 includes an act of generating an augmented insight describing the data chart in natural language by replacing the placeholder name in the placeholder insight with the entity name. In some embodiments, the series of acts 900 includes an act of determining a set of multiple words that define the entity name within the template-based caption. In one or more embodiments, the series of acts 900 includes an act of extracting the set of multiple consecutive words from the template-based caption.

In some cases, the series of acts 900 includes an act of mapping the entity name to the placeholder name by generating a simplified name by truncating a word from the set of multiple words and excluding one or more other words from the set of multiple words. In certain embodiments, the series of acts 900 includes an act of generating the placeholder name by combining an entity name designator, the longest word of the entity name, and an entity name count. In the same or other embodiments, the series of acts 900 includes an act of generating a placeholder pair by associating the entity name with the placeholder name. In some examples, the series of acts 900 includes an act of adding the placeholder pair to the renaming map based on an order of the entity name within the entity list.

In certain cases, the series of acts 900 includes an act of replacing the entity name with the placeholder name based on the order of the entity name within entity list. In one or more embodiments, the series of acts 900 includes an act of generating the modified caption from the template-based caption by replacing a second instance of the entity name with a second instance of the placeholder name utilizing the renaming map. In these or other embodiments, the series of acts 900 includes an act of generating the augmented insight by replacing a second instance of the placeholder name in the placeholder insight with the entity name. In certain cases, the series of acts 900 includes an act of generating a modified caption from the template-based caption by replacing an additional entity name with an additional placeholder name utilizing the renaming map. In some embodiments, the series of acts 900 includes an act of generating the augmented insight by replacing the additional placeholder name in the placeholder insight with the additional entity name.

FIG. 10 illustrates a series of acts 1000 for distilling a natural language model into a distilled insight model for generating distilled placeholder insights from captions in accordance with one or more embodiments. As shown, the series of acts 1000 includes acts 1002-1008. For example, the act 1002 includes determining a set of training captions. Specifically, the act 1002 includes determining a set of training captions comprising template-based captions describing data charts according to one or more insight templates. In addition, the act 1004 includes generating modified training captions by replacing entity names with placeholder names. Specifically, the act 1004 involves generating a set of modified training captions from the set of training captions by replacing entity names with placeholder names within the set of training captions. Further, the act 1006 includes generating, via a natural language model, a placeholder insight incorporating a placeholder name. Specifically, the act 1006 involves generating, via a natural language model from the set of modified training captions, at least one placeholder insight describing a data chart in natural language phrases incorporating a placeholder name in place of an entity name. In addition, the act 1008 includes distilling the natural language model into a distilled insight model. Specifically, the act 1008 involves distilling the natural language model into a distilled insight model by tuning parameters of the distilled insight model based on the at least one placeholder insight.

In one or more embodiments, the series of acts 1000 includes an act of comparing a placeholder insight generated by the natural language model to a distilled placeholder insight generated by the distilled insight model. In some examples, the series of acts 1000 includes an act of modifying parameters of the distilled insight model based on comparing the placeholder insight to the distilled placeholder insight.

In certain cases, the series of acts 1000 includes an act of selecting the set of training captions based on a caption type. In one or more embodiments, the series of acts 900 includes an act of generating the set of modified training captions by generating a modified training caption from a template-based training caption by replacing an entity name with a placeholder name. In these or other embodiments, the series of acts 900 includes an act of generating, utilizing the distilled insight model to process the modified training caption, a distilled placeholder insight using the placeholder name. In certain cases, the series of acts 900 includes an act of generating the modified caption from the template-based caption by replacing the entity name with the placeholder name based on an order defined by an entity list organized according to entity name lengths.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 11 illustrates, in block diagram form, an example computing device 1100 (e.g., the computing device 800, the client device(s) 108, and/or the server device(s) 102) that may be configured to perform one or more of the processes described above. As shown by FIG. 11, the computing device can comprise a processor(s) 1102, memory 1104, a storage device 1106, an I/O interface 1108, and a communication interface 1110.

In particular embodiments, processor(s) 1102 includes hardware for executing instructions, such as those making up a computer program. As an example, and not by way of limitation, to execute instructions, processor(s) 1102 may retrieve (or fetch) the instructions from an internal register, an internal cache, memory 1104, or a storage device 1106 and decode and execute them. The computing device 1100 includes memory 1104, which is coupled to the processor(s) 1102. The memory 1104 may be used for storing data, metadata, and programs for execution by the processor(s). The memory 1104 may include one or more of volatile and non-volatile memories. The memory 1104 may be internal or distributed memory. The computing device 1100 includes a storage device 1106 includes storage for storing data or instructions. As an example, and not by way of limitation, storage device 1106 can comprise a non-transitory storage medium described above. The computing device 1100 also includes one or more input or output (“I/O”) devices/interfaces 1108, which are provided to allow a user to provide input to (such as user strokes), receive output from, and otherwise transfer data to and from the computing device 1100. These I/O devices/interfaces 1108 may include a mouse, keypad or a keyboard, a touch screen, camera, optical scanner, network interface, modem, other known I/O devices or a combination of such I/O devices/interfaces 1108.

The computing device 1100 can further include a communication interface 1110. The communication interface 1110 can include hardware, software, or both. The communication interface 1110 can provide one or more interfaces for communication (such as, for example, packet-based communication) between the computing device and one or more other computing devices (e.g., computing device 1100) or one or more networks. The computing device 1100 can further include a bus 1112. The bus 1112 can comprise hardware, software, or both that couples components of computing device 1100 to each other.

What is claimed is:

1. A computer-implemented method comprising:
extracting, using an insight augmentation algorithm that includes a renaming map and a large language model, an entity name from a template-based caption describing data according to an insight template;
generating, utilizing the renaming map, a modified caption from the template-based caption by replacing the entity name with a placeholder name;
generating, utilizing the large language model to process the modified caption, a placeholder insight describing the data in natural language using the placeholder name; and
generating, using the insight augmentation algorithm, an augmented insight describing the data in natural language by replacing the placeholder name in the placeholder insight with the entity name.

2. The computer-implemented method of claim 1, wherein extracting the entity name comprises:
determining a set of multiple consecutive words that define the entity name within the template-based caption; and
extracting the set of multiple consecutive words from the template-based caption.

3. The computer-implemented method of claim 1, further comprising:
generating an entity list that includes the entity name and one or more additional entity names from the template-based caption;
sorting the entity list according to entity name lengths; and
mapping the entity name to the placeholder name within the renaming map in an order defined by the entity list.

4. The computer-implemented method of claim 1, further comprising mapping the entity name to the placeholder name utilizing the renaming map, wherein the placeholder name includes a longest word and excludes one or more other words from the entity name within the template-based caption.

5. The computer-implemented method of claim 4, further comprising:
generating the placeholder name by generating a placeholder rubric defining placement of an extracted term between an entity name designator and an entity name count; and
populating the placeholder rubric with the longest word of the entity name as the extracted term.

6. The computer-implemented method of claim 1, wherein the large language model is trained to understand placeholder names.

7. The computer-implemented method of claim 1, further comprising:
generating the modified caption from the template-based caption by replacing a second instance of the entity name with a second instance of the placeholder name utilizing the renaming map; and
generating the augmented insight by replacing a second instance of the placeholder name in the placeholder insight with the entity name.

8. The computer-implemented method of claim 1, further comprising:
generating a modified caption from the template-based caption by replacing an additional entity name with an additional placeholder name utilizing the renaming map;
generating, utilizing the large language model to process the modified caption, the placeholder insight describing the data in natural language using the additional placeholder name; and
generating the augmented insight describing the data in natural language by replacing the additional placeholder name in the placeholder insight with the additional entity name.

9. A system comprising:
one or more memory devices; and
one or more processors coupled to the one or more memory devices, the one or more processors configured to cause the system to:
generate, using an insight augmentation algorithm, a modified caption from a template-based caption describing a data chart by:
sorting an entity list that includes an entity name extracted from the template-based caption according to entity name lengths;
generating, from the entity list, a renaming map that maps the entity name to a placeholder name; and
replacing the entity name within the template-based caption with the placeholder name;
generate, using a large language model to process the modified caption, a placeholder insight describing the data chart in natural language using the placeholder name by rephrasing the modified caption into natural language phrases according to parameters of the large language model; and
generate, using the insight augmentation algorithm, an augmented insight describing the data chart in natural language by replacing the placeholder name in the placeholder insight with the entity name.

10. The system of claim 9, wherein the one or more processors are further configured to cause the system to extract the entity name from the template-based caption by:
determining a set of multiple consecutive words that define the entity name within the template-based caption; and
extracting the set of multiple consecutive words from the template-based caption.

11. The system of claim 10, wherein the one or more processors are further configured to cause the system to map the entity name to the placeholder name by generating a simplified name by truncating a word from the set of multiple consecutive words and excluding one or more other words from the set of multiple consecutive words.

12. The system of claim 9, wherein generating the renaming map comprises:
generating the placeholder name by combining an entity name designator, a longest word of the entity name, and an entity name count;
generating a placeholder pair by associating the entity name with the placeholder name; and
adding the placeholder pair to the renaming map based on an order of the entity name within the entity list.

13. The system of claim 12, wherein replacing the entity name within the template-based caption with the placeholder name comprises replacing the entity name with the placeholder name based on the order of the entity name within the renaming map.

14. The system of claim 9, wherein the one or more processors are further configured to cause the system to:
generate the modified caption from the template-based caption by replacing a second instance of the entity name with a second instance of the placeholder name utilizing the renaming map; and
generate the augmented insight by replacing a second instance of the placeholder name in the placeholder insight with the entity name.

15. The system of claim 9, wherein the one or more processors are further configured to cause the system to:
generate a modified caption from the template-based caption by replacing an additional entity name with an additional placeholder name utilizing the renaming map; and
generate the augmented insight by replacing the additional placeholder name in the placeholder insight with the additional entity name.

16. A computer-implemented method comprising:
determining a template-based caption describing a data chart according to an insight template;
performing a step for generating an augmented insight describing the data chart in natural language phrases; and
providing the augmented insight for display on a client device.

17. The computer-implemented method of claim 16, further comprising:
comparing a placeholder insight generated by a natural language model to a distilled placeholder insight generated by a distilled insight model; and
modifying parameters of the distilled insight model based on comparing the placeholder insight to the distilled placeholder insight.

18. The computer-implemented method of claim 16, wherein providing the augmented insight for display comprises providing an insight interface depicting the data chart and the augmented insight together.

19. The computer-implemented method of claim 16, wherein the operations further comprise:
generating a modified training caption from a template-based training caption by replacing an entity name with a placeholder name; and
generating, utilizing a distilled insight model to process the modified training caption, a distilled placeholder insight using the placeholder name.

20. The computer-implemented method of claim 19, wherein the operations further comprise generating the modified training caption from the template-based training caption by replacing the entity name with the placeholder name based on an order defined by an entity list organized according to entity name lengths.
